(19) United States
(12) Patent Application Publication
(10) Pub. No.: US 2006/0037869 A1
(43) Pub. Date: Feb. 23, 2006

(54) Scented electrolysis product

(75) Inventor: Curtis M. Mitchke, Albuquerque, NM (US)

Correspondence Address: PEACOCK MYERS, P.C., 201 THIRD STREET, N.W., SUITE 1340, ALBUQUERQUE, NM, 87102, US

(73) Assignee: MIOX Corporation, Albuquerque, NM (US)

(21) Appl. No.: 11/208,825

(22) Filed: Aug. 19, 2005

Related U.S. Application Data
(60) Provisional application No. 60/602,775, filed on Aug. 19, 2004.

(51) Int. Cl. C02F 1/461; C25B 9/00

(52) U.S. Cl. 205/701; 205/742; 204/242; 204/275.1; 204/278

(57) ABSTRACT

An apparatus and method for adding a scent to an electrolysis product such as mixed oxidants. The scent may alert the user to low concentrations of oxidants, for example in disinfection applications, so that the required minimum disinfection or decontamination strength is maintained. The scent may also serve as a safety marker to alert a user to dangerous concentrations of electrolysis byproducts such as hydrogen gas.

### CROSS-REFERENCE TO RELATED APPLICATIONS

This application claims the benefit of the filing of U.S. Provisional Patent Application Ser. No. 60/602,775, entitled “Scented Electrolyte Cartridge”, filed Aug. 19, 2004. This application is related to U.S. patent application Ser. No. 10/785,610, to Rodney E. Herrington, entitled “Electrolytic Cell for Surface and Point of Use Disinfection” which is a continuation-in-part application of U.S. patent application Ser. No. 09/907,092, filed on Jul. 16, 2001, and issued as U.S. Pat. No. 6,736,966 on May 18, 2004, entitled “Portable Water Disinfection System”, and which also claims priority to U.S. Provisional Patent Application Ser. No. 60/448,994, entitled “Electrolytic Cell for Surface and Point of Use Disinfection”, filed Feb. 21, 2003. This application is also related to U.S. patent application Ser. No. 10/785,892 entitled “Gas Drive Electrolytic Cell”, filed on Feb. 23, 2004. The specifications and claims of all these applications and patents are incorporated herein by reference.

### BACKGROUND OF THE INVENTION

1. Field of the Invention (Technical Field)

This invention relates to the production of a scented disinfectant or scented by-product resulting from the preferably electrolytic production of disinfectant. An oxidant and scent are preferably introduced into an aqueous solution which can then be used as a disinfectant or sanitizing liquid.

2. Description of Related Art

Note that the following discussion refers to a number of publications by authors and year of publication, and that due to recent publication dates certain publications are not to be considered as prior art vis-a-vis the present invention. Discussion of such publications herein is given for more complete background and is not to be construed as an admission that such publications are prior art for patentability determination purposes.

This invention involves electrolytic technology known generally in the art. Electrolytic technology utilizing dimensionally stable anodes (DSA) has been used for years for the production of chlorine and other mixed-oxidant solutions. Dimensionally stable anodes are described in U.S. Pat. No. 3,234,110, to Beer, entitled “Electrode and Method of Making Same”. An example of an electrolytic cell with membranes is described in U.S. Pat. No. RE 32,077, to deNora, et al., entitled “Electrode Cell with Membrane and Method for Making Same”. An electrolytic cell with dimensionally stable anodes without membranes is described in U.S. Pat. No. 4,761,208, to Gram, et al., entitled “Electrolytic Method and Cell for Sterilizing Water.”

The invention also involves the use of electrolytic cells to produce an oxidant. Commercial electrolytic cells have been used routinely for oxidant production that utilizes a flow-through configuration that may or may not be under pressure that is adequate to create flow through the electrolytic device. Examples of cells of this configuration are described in U.S. Pat. No. 6,309,523, to Prasnikar, et al., entitled “Electrode and Electrolytic Cell Containing Same,” and U.S. Pat. No. 5,385,711, to Baker, et al., entitled “Electrolytic Cell for Generating Sterilization Solutions Having Increased Ozone Content,” and many other membrane-type cells. In other configurations, the oxidant is produced in an open-type cell or drawn into the cell with a syringe or pump-type device, such as described in U.S. Pat. No. 6,524,475, to Herrington, et al., entitled “Portable Water Disinfection System.”

A specific type of electrolytic cell that produces an oxidant is disclosed in U.S. patent application Ser. No. 09/907,092, to Herrington, et al., entitled “Portable Water Disinfection System,” the specification of which is incorporated herein by reference. The specification describes disinfection devices that utilize, in one instance, an electrolytic cell chamber in which hydrogen gas is generated during electrolysis to provide a driving force to expel oxidant from the cell chamber through a pressure-sensitive check valve. In this configuration, unconverted electrolyte is also expelled from the body of the cell as hydrogen gas is generated. In an alternate configuration described in the same application, hydrogen gas pressure is contained in a cell chamber during electrolysis, but the pressure within the cell chamber is limited by the action of a spring-loaded piston that continues to increase the volume of the cell chamber as gas volume increases. Ultimately, a valve mechanism opens, and the spring-loaded piston fills the complete volume of the cell chamber forcing the oxidant out of the cell chamber.

U.S. Pat. No. 3,996,126, to Rasmussen describes an electrolyzed saline solution generated in a closed container and used to treat teeth and oral cavities. A propellant gas, electrical pump, or manual pump is utilized to force the electrolyzed saline solution out of the container through a tube.

U.S. Pat. No. 4,019,986, to Burris, et al, describes a portable ozone generator and container for purifying water. U.S. Application U.S. 2002/0175085 A1, to Harkins, et al, relates to a stationary electrolyzed oxidizing water system for spraying a sanitizing solution on eggs. U.S. Pat. No. 6,502,766, to Streutker, et al, relates to a motorized sprayer for attachment to a bottle. U.S. Pat. No. 6,363,951, to Wood describes an ozone generation system for use in a water-containing device, such as a sink, for disinfection of materials placed in the device.

These prior art systems do not create a scented disinfectant. Since the disinfecting action of electrolyzed solutions degrades over time, there is a present need for a scented disinfectant, particularly a disinfectant which has a scent that decreases or changes as the disinfecting properties decrease, thus alerting the user to the degradation in disinfecting effectiveness. In addition, hydrogen gas is produced in the electrolysis process, and is a colorless and odorless gas. For safety reasons, there is a present need to detect the presence of hydrogen gas in the environment. Hydrogen can react with chemical constituents that are added to the electrolyte in order to produce a scent that notifies the user that hydrogen gas is present in the environment.

### SUMMARY OF THE INVENTION (DISCLOSURE OF THE INVENTION)

The present invention is a method for producing a scented electrolysis product, the method comprising the steps of producing an electrolysis product, adding the electrolysis product to a fluid, and providing a scent to the fluid. The electrolysis product preferably comprises an oxidant. The fluid preferably comprises water. The electrolysis product and water combination preferably comprises a disinfectant solution, in which case the method preferably further comprises the step of applying the disinfectant solution to a surface or an object. The method preferably further comprises the step of the scent neutralizing chlorinous odors. A quality of the scent, preferably the strength and/or flavor, is preferably related to a concentration of electrolysis product in the fluid. The method preferably further comprises the step of adding a second scent to the fluid, wherein the strength of the second scent is not related to the concentration of electrolysis product. The method optionally further comprises the step of producing the scent during electrolysis, in which case the scent is preferably produced at a rate related to a production rate of at least one undesirable gaseous electrolysis byproduct, for example hydrogen gas.

The present invention is also an apparatus for producing a scented electrolysis product, the apparatus comprising an electrolyte container, an electrolytic cell, a fluid container, and a scent container. The fluid optionally flows continuously through the container. The fluid preferably comprises water. The scent is optionally added either to the electrolytic cell before electrolysis is performed or to the fluid container. The apparatus preferably further comprises a system for venting gaseous electrolysis byproducts. The byproducts are preferably selected from the group consisting of scent, hydrogen gas, and combinations thereof. One or more of the containers is preferably replaceable.

An object of the present invention is to add a scent to an electrolysis product such as mixed oxidants so that the strength or concentration of the product can easily be determined by the user.

An advantage of the present invention is that high concentrations of dangerous odorless gases produced during electrolysis, such as hydrogen, may be detected by a user by adding a scent which is produced or released in proportion to the production rate or concentration of the gases.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a drawing depicting a side view of a bottle mounted on an oxidant-producing base unit;

FIG. 2 is a drawing depicting a side view of a bottle with an oxidant producing unit housed within the handle of the bottle; and

FIG. 3 is a drawing depicting a side view of a bottle with a separate replaceable oxidant-producing device or module removably attached to the bottle.

### DETAILED DESCRIPTION OF THE INVENTION

The word “sanitize” may means to make sanitary, as by cleaning or sterilizing. The word “disinfect” may mean to free from infection, especially by destroying harmful microorganisms; broadly, to cleanse. The word “disinfectant” means: a chemical that destroys vegetative forms of harmful microorganisms, especially on inanimate objects. As used throughout the specification and claims, the term “disinfect” also means to sanitize, cleanse, decontaminate, or the like. As used throughout the specification and claims, the term “disinfectant” also means a product which disinfects, sanitizes, decontaminates, or cleans, such as a sanitizer, cleanser, or the like.

The term “scent” and “scented” as used throughout this application is intended to include any and all types of scents including, but not limited to odors, smells, fragrances, perfumes, aromas, and colognes. Further, the term “scent” is also intended to include any molecule, mixture, compound, or substance which emits an odor prior to undergoing electrolysis, after undergoing electrolysis, or after reacting with an oxidant. As such, the molecule, mixture, compound, or substance can, but need not necessarily, always emit an odor.

The present invention preferably comprises electrolytic cartridge 32 which, in addition to containing an electrolyte, preferably comprises one or more scents. The scents used can include both electrolysis-activated scents and non-electrolysis-activated scents, either independently or in combination. Electrolysis-activated scents can simply be additives that produce little or no odor prior to activation, and the non-electrolysis-activated scents can be scented additives which continuously emit an aroma regardless of whether or not they have undergone electrolysis. As such, these non-electrolysis-activated scents preferably remain substantially unchanged after passing through electrolytic cell 46.

Commercial electrolytic cells can be used to produce a mixed-oxidant solution. This process is described in U.S. Pat. No. 4,761,208 and subsequent patents and applications, referred to above, all incorporated herein by reference. The disinfectant produced in this process is very effective for inactivation of microorganisms, particularly microorganisms that are resistant to treatment by conventional chlorine, whether in gas, liquid (sodium hypochlorite), or solid (calcium hypochlorite) form.

One embodiment of the present invention incorporates an electrolytic cartridge, preferably containing one or more scents, into a spray bottle or other container for cleaning solution to enhance the disinfection performance of the cleaning solution and to permit a scent to be incorporated into the cleaning solution. The scent preferably decreases in strength or otherwise changes in aroma as the disinfecting action decreases. The scent may optionally indicate the presence of hydrogen. The cleaning solution may have many applications including household or industrial surface cleaning (countertops, lavatories, etc), an enhanced cleaning and disinfection solution for washing hands in a sterile environment, for the cleaning of medical instruments, and any other application where inactivation of viruses, bacteria, protozoans, molds, spores, volatile organic compounds, pesticides, herbicides, chemical contamination agents, cyanide, and other undesirable matter can be destroyed by the oxidant solution.

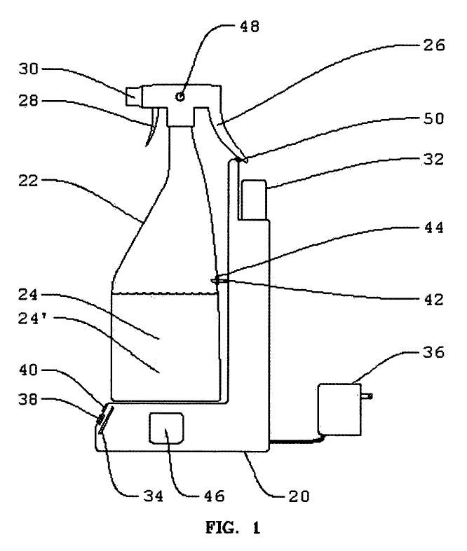

Referring to FIG. 1, one embodiment of the present invention comprises base unit 20 with bottle 22 placed on a horizontal surface for receiving the bottle. In this embodiment, bottle 22 comprises a spray bottle. In alternative embodiments of the present invention, the bottle may be a closed or capped bottle, or an open bottle. In the first embodiment, base unit 20 comprises electrolytic cell 46 which generates an oxidant, circuit board 34, and electrolyte storage container 32 which also stores one or more scents. In this embodiment, power supply 36 is attached by an electrical cord to base unit 20 and plugs directly into a wall electrical outlet. In an alternative embodiment of the present invention, power supply 36 is located within base unit 20 and plugged directly into an electrical outlet.

In order to commence operation, fluid 24, preferably water, is introduced into bottle 22, which is placed on base unit 20. Activation switch 38 is pressed by the user thus activating production of oxidants and optional emission of one or more scents. Electrolyte within storage container 32 is transferred to electrolytic cell 46. Electrical power is applied to electrolytic cell 46 through control circuit 34. Status of oxidant production and scent additive levels and fault conditions such as low electrolyte or other conditions are preferably indicated by illumination of status lights 40. Upon completion of oxidant generation within electrolytic cell 46, oxidants and one or more scents are transferred to the interior of bottle 22 via valve 44 and probe 42. Probe 42 preferably provides fluid communication with the liquid in bottle 22, via self-sealing valve 44 which is incorporated within bottle 22. Other user-controlled or automatic apparatuses may be employed to transfer the electrolyte to the solution within bottle 22. After oxidants and scent(s) are transferred to the interior of bottle 22, they mix with and/or dissolve into fluid 24, thus creating fluid 24′ which now comprises a free available chlorine concentration of sufficient strength to sanitize desired objects.

Bottle 22 is then removed from base unit 20 and is transported by the user to other locations for the purpose of disinfecting or sanitizing surfaces, food products, or other materials. Bottle 22 preferably comprises handle 26 which preferably further comprises spray trigger 28 and spray nozzle 30. In the first embodiment, handle 22 comprises oxidant efficacy indicator light 48. Oxidant efficacy indicator light 48 preferably provides status to the user of the free available chlorine oxidant strength in fluid 24. Oxidant efficacy indicator light 48 can be used in conjunction with one or more scents which are stored in electrolytic cartridge 32 and introduced into fluid 24. Oxidant efficacy indicator light 48 is preferably activated via electrical contact 50 and is preferably powered from a capacitor circuit located within handle 26. Oxidant efficacy indicator light 48 is optionally powered by a battery located within handle 26. In this alternative embodiment, activation of oxidant efficacy indicator light 48 is triggered by a radio frequency signal generated by an RF circuit located within base unit 20.

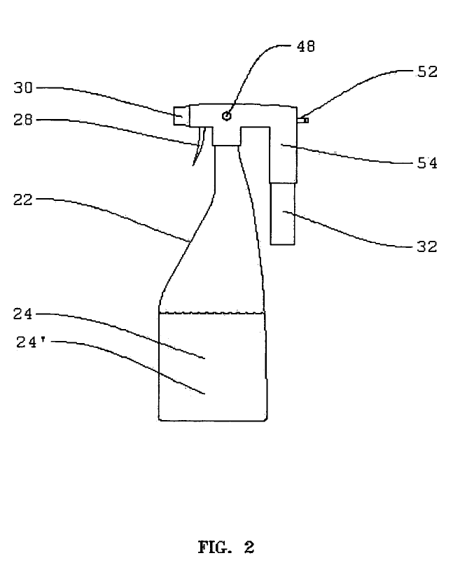

An alternative embodiment of the present invention is shown in FIG. 2. Sprayer head 54 preferably comprises an electrolytic cell, a power supply, a control circuit, sprayer nozzle 30, spray handle 28, and electrolyte container 32. Sprayer head 54 also preferably includes oxidant efficacy indicator light 48. Sprayer head 54 preferably plugs directly into an electrical wall outlet via electrical connector 52 to provide power to recharge a battery located within sprayer head 54. The battery within sprayer head 54 provides the power to deliver a charge to the electrolyte within the electrolytic cell to produce oxidants. In an alternative embodiment, electrolysis within the cell within sprayer head 54 is powered directly from the electrical wall outlet via electrical connectors 52.

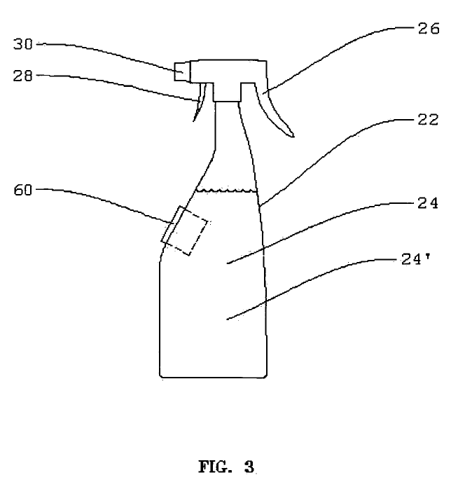

Yet another embodiment of the present invention is shown in FIG. 3. In this embodiment, electrolytic cell module 60 preferably comprises an electrolytic cell, electrolyte source, power source, and control circuit. Electrolytic cell module 60 is preferably removable from bottle 22, preferably by threads or other mechanical fluid-tight sealing mechanism to bottle 22, preferably for replacement as a complete assembly from bottle 22. The electrolytic cell, electrolyte source, and/or power source are optionally replaceable components that attach to or form part of electrolytic cell module 60. Electrolytic cell module 60 preferably comprises the electrolytic cell and control circuit. The oxidant and scent(s) produced by electrolytic cell module 60 are preferably in fluidic connection with the liquid in bottle 22.

In the above embodiments, after oxidant is added to the water or other liquid in the spray bottle and thereby diluted, it is preferably that the oxidant has a concentration ranging from about 50 ppm to about 200 ppm, more preferably between about 80 ppm to about 120 ppm, and most preferably about 100 ppm in the solution when it is applied to the surface or object to be disinfected. Inactivation studies have shown that a concentration of 100 ppm is optimal to obtain 3-log inactivation of harmful microorganisms. Because the present invention preferably produces mixed oxidants, which unlike other chlorine-based disinfectants typically don't produce di- and tri-chloramines or other compounds which cause objectionable tastes and odors, such high concentrations produce a solution which when sprayed, atomized, or misted is far more acceptable to the user. In certain circumstances an initial concentration of up to about 200 ppm or greater may be desirable, for example because the water may contain chloramines in water (from municipal treatment) which would react with the mixed oxidants, reducing the concentration. In that case, there would still be a concentration of approximately 100 ppm left for disinfection at the time the solution is applied to the surface or object. The concentration produced by the present invention is optionally controllable, either automatically or manually, to achieve the desired final concentration depending on the application. For example, the present invention may include a sensor to measure the water's natural TDS levels and adjust the oxidant concentration based on the results.

The mixed oxidants produced by the present invention preferably comprise both the anode and cathode electrolysis products, unlike previous electrolytic cells which typical use only the anode (acidic) products and discard the cathode products as waste. Thus the pH of the present oxidants is preferably between about 7 and about 10, and most preferably approximately 9.

In any of the present embodiments, at least one scent-producing additive is preferably added to electrolytic cartridge 32 or electrolytic cell module 60. While any type of scent will produce desirable results, it is preferable that the scent be an oxidant-dependent scent which requires one or more oxidants to emit its aroma. In this embodiment, the scent degrades as the quantity of oxidants decreases. Since the disinfecting power of the disinfectant decreases as the quantity of oxidants decreases, a scent is thus produced which is directly proportional to the disinfecting strength of the disinfectant. Further, the scent may optionally be oxidized by the oxidant and thus consumed by the oxidant. In this embodiment, the strength of the aroma decreases as it is consumed by the oxidant. The flavor of the scent can also change as the scent is consumed by the oxidant. Thus, as the quantity of the oxidant decreases, the strength and/or flavor of the scent also changes.

The oxidant-dependent scent described above may optionally be combined with a second scent which is stored in electrolytic cartridge 32 or electrolytic cell module 60 and subsequently introduced into the disinfecting solution. In this embodiment, it is preferable that the second scent be a mild-strength scent which does not decrease proportionally with respect to the oxidant concentration. Thus, as the first scent decreases in concentration, a user perceives a shift in the smell of the scent from the first oxidant-dependent scent to the more mild, non-oxidant-dependent scent. While any scent can be used for this embodiment, it is preferable that the first scent used be a scent which gives the impression of a product that is fresh, and that the second scent used be one which gives the impression of a stale product. Thus, a user knows the effectiveness of the disinfectant based on how fresh it smells.

One or more scents may optionally be added to electrolytic cartridge 32 or electrolytic cell module 60 as a safety mechanism. Electrolysis of hydrogen-containing compounds typically produces hydrogen gas. A scent agent is preferably added in low concentrations. The amount of scent produced during electrolysis is preferably directly proportional to amount of hydrogen gas produced. If the system is insufficiently vented, the concentrations of both the scent and the hydrogen gas will increase. Thus, if the scent increases to detectable levels, users are warned that a dangerous buildup of hydrogen gas is occurring (similar to the addition of sulfurous gas to odorless natural gas). The user then knows that the system needs to be shut down and the area should be allowed to vent. In a positively vented on-site generator, all gases and molecules (heavy or light) will vent similarly because there will be sufficient airflow. However, in a passively vented system, while virtually any scent can be used to warn users of a buildup of hydrogen gas, it is preferable that the scent used be a gas or molecule which is very light and will vent in a manner similar or proportional to hydrogen gas.

In any of the embodiments contained herein, the one or more scents can be pre-mixed with the electrolyte in the electrolyte cartridge, stored in a cartridge separate from the electrolyte, or stored in a separate section of a cartridge containing an electrolyte. Either may be replaceable. If the one or more scents are not pre-mixed with the electrolyte cartridge, the one or more scents can be mixed with the electrolyte before entering the electrolytic cell, or one or more of the scents can bypass the electrolytic cell entirely and subsequently be mixed with the oxidant. For example, after generating and injecting the oxidants into the spray bottle or another receptacle, the scent may be added to the bottle or receptacle. The one or more scents may comprise a solid, liquid, gas, or combination thereof and may be added to any vessel, including but not limited to vessels containing an electrolyte, brine, or salt, but the scents are preferably added to salt bags or directly to a brine generator.

The electrolyte cartridge and/or the scent cartridge are preferably replaceable, and thus preferably are consumable products which can be sold separately. By including a required electronic component in the replacement cartridge, it may be possible to prevent third party or unauthorized replacement cartridges from being used. Further, if the cartridge is opened to refill it with electrolyte components such as salt or water, the component may be destroyed. For example, for the electrolyte cartridge, the component may optionally comprise the cathode or the anode, optionally comprising a sturdy foil, which is placed so that the connector is damaged or destroyed if the cartridge is opened or otherwise tampered with. Alternatively, the component may comprise a non-obvious conductor or conducting element which completes the electrolysis circuit. The conducting element may even be formed as part of the cartridge body itself.

Alternatively, an RF or other type of tagging or security chip, such as an RFID chip, may be placed in the electrolyte and/or scent cartridge which could be recognized by a chip in the base, so that only authorized replacement cartridges may be used. In addition, such a chip could track the number of times the cartridge has been used, and a counter could alert the user that it is time to replace the cartridge. The spray bottle may also comprise such a chip so that the system can verify that the bottle is in contact with the base when oxidant is being produced. This function may alternatively be performed by a device such as a simple interlock or proximity switch or contact. However, if a scent tags the oxidant strength as described above, and if the cartridge is tamper proof, the apparatus likely would not need a counter, RFID, or any other indicator, thus keeping full functionality while reducing costs.

The invention is not limited to the spray bottle configurations set forth herein. Scents, as described above, may be utilized in any electrolysis which is capable of storing, producing, and/or modifying scents. For example, a scent or odor may be used in larger commercial applications. In large systems, the electrolyte cartridge is often replaced with a bulk commercial brine silo, and the odor or scent causing agent can be applied to the water or salt feed streams to the bulk brine silo, or may be added to the brine generated in the bulk brine silo. The detection of hydrogen is especially important for larger systems because hydrogen can be produced in significant quantities. In addition, other variations and configurations of an electrolytic cell can be produced to accommodate various applications. For example, a simple version of an oxidant-producing device useful in the present invention is described and shown in FIGS. 1, 2, and 3 of commonly owned U.S. Pat. No. 6,736,966 for “Portable Water Disinfection System”, incorporated herein by reference.

Scents which can mask chlorinous odors in treated water are particularly preferable for use with the present invention. Rather than preventing the formation of chlorinous odors (such as di- and tri-chloramines), treated water can contain a scent that neutralizes such odors. The present invention can thus be used in swimming pools, hot tubs, cooling towers, and the like. When used in such a manner in conjunction with a scent which neutralizes such odors, the waters of such devices preferably emit a light fragrance rather than a chlorine smell.

It will be obvious to those versed in the art that the present invention can be utilized in a variety of applications including spray bottle applications for surface cleaning, potable water treatment systems, wastewater treatment systems, food cleaning applications, medical instrument sterilization, surgical wards, hospital environments, military medical applications, military chemical and biological weapons decontamination, wound treatment, and other applications where a disinfectant is utilized. Further, if the present invention is used in conjunction with food cleaning or food utensil cleaning applications, the scent that is used may optionally comprise one or more food flavoring additives. For example, an artificial or natural orange or lemon flavoring agent can be used.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above, and of the corresponding applications, are hereby incorporated by reference.

What is claimed is:

1. A method for producing a scented electrolysis product, the method comprising the steps of:
producing an electrolysis product;
adding the electrolysis product to a fluid; and
providing a scent to the fluid.

2. The method of claim 1 wherein the electrolysis product comprises an oxidant.

3. The method of claim 1 wherein the fluid comprises water.

4. The method of claim 1 wherein the electrolysis product and water combination comprises a disinfectant solution.

5. The method of claim 1 further comprising the step of the scent neutralizing chlorinous odors.

6. The method of claim 1 wherein a quality of the scent is related to a concentration of electrolysis product in the fluid.

7. The method of claim 6 wherein the quality is selected from the group consisting of strength and flavor.

8. The method of claim 6 further comprising the step of adding a second scent to the fluid, wherein a strength of the second scent is not related to the concentration of electrolysis product.

9. The method of claim 1 further comprising the step of producing the scent during electrolysis.

10. The method of claim 9 wherein the scent is produced at a rate related to a production rate of at least one undesirable gaseous electrolysis byproduct.

11. The method of claim 10 wherein the gaseous electrolysis byproduct comprises hydrogen gas.

12. The method of claim 4 further comprising the step of applying the disinfectant solution to a surface or an object.

13. An apparatus for producing a scented electrolysis product, the apparatus comprising:
an electrolyte container;
an electrolytic cell;
a fluid container; and
a scent container.

14. The apparatus of claim 13 wherein said fluid flows continuously through the container.

15. The apparatus of claim 13 wherein said fluid comprises water.

16. The apparatus of claim 13 wherein said scent is added to said electrolytic cell before electrolysis is performed.

17. The apparatus of claim 13 wherein said scent is added to said fluid container.

18. The apparatus of claim 13 further comprising a system for venting gaseous electrolysis byproducts.

19. The apparatus of claim 18 wherein said byproducts are selected from the group consisting of scent, hydrogen gas, and combinations thereof.

20. The apparatus of claim 13 wherein one or more of said containers is replaceable.
